(19) United States
(12) Patent Application Publication
(10) Pub. No.: US 2014/0142005 A1
(43) Pub. Date: May 22, 2014

(54) POTASH PROCESSING WITH A VAPOR-COMPRESSION CYCLE

(71) Applicants: J. Clair Batty, North Logan, UT (US); Brett Boissevain, Logan, UT (US)

(72) Inventors: J. Clair Batty, North Logan, UT (US); Brett Boissevain, Logan, UT (US)

(73) Assignee: UTAH STATE UNIVERSITY, North Logan, UT (US)

(21) Appl. No.: 14/084,250

(22) Filed: Nov. 19, 2013

Related U.S. Application Data
(60) Provisional application No. 61/728,700, filed on Nov. 20, 2012.

(51) Int. Cl. C01D 3/06; E21B 43/28

(52) U.S. Cl. CPC C01D 3/06; E21B 43/28
USPC 507/276; 422/244; 423/184; 299/4

(57) ABSTRACT

A potash-extraction system and method for extracting potash from a brine containing potash without the use of water-consuming evaporation ponds or additional chemicals is disclosed. The potash processing system uses a vapor-compression cycle (e.g., heat pump or refrigeration system) to separate potash from brine containing potash and NaCl. In embodiments, heat emitted by components of the vapor-compression cycle (e.g., condenser heat exchanger, evaporator heat exchanger) may heat the brine to precipitate some NaCl from the brine. The remaining potash-concentrated brine may then be cooled to precipitate potash from the solution. The precipitated potash may then be further processed for final use.

### RELATED APPLICATIONS

This application claims priority to U.S. Provisional Patent Application No. 61/728,700, filed Nov. 20, 2012, the entirety of which is herein incorporated by reference.

### TECHNICAL FIELD

The present disclosure relates to extracting potash from a brine solution containing potassium chloride (“KCl” or “potash”) and Sodium Chloride (“NaCl” or “salt”).

### BACKGROUND

Potash refers to potassium containing compounds, particularly potassium chloride. Potash is primarily used with nitrogen and phosphorus in fertilizers. One method for producing potash includes injecting a mine containing potash deposits with water or a salt-saturated brine, which dissolves crystals containing potash. The potash-containing brine is then pumped out of the mine and deposited in nearby evaporation ponds where potash and salt precipitate out of the brine solution as the water evaporates. The precipitated potash and salt are then gathered and transported to a processing facility where potash and salt are chemically separated and the potash is processed for sale. This process requires large evaporation ponds located close to the potash mine and additional chemical processing at a potash processing facility.

### SUMMARY

### 1. Summary (Benefits)

1.1. System and Method Overview

The present disclosure in aspects and embodiments describes a potash-extraction system and method for extracting potash from a brine containing potash without the use of water-consuming evaporation ponds or additional chemicals. The potash processing system uses a vapor-compression cycle (e.g., heat pump or refrigeration system) to separate potash from brine containing potash and NaCl. In embodiments, heat emitted by components of the vapor-compression cycle (e.g., condenser heat exchanger, evaporator heat exchanger) may heat the brine to precipitate some NaCl from the brine. The remaining potash-concentrated brine may then be cooled to precipitate potash from the solution. The precipitated potash may then be further processed for final use.

1.2. Using the Temperature-Dependent Solubility of Potash and Salt

The potash extraction system and method take advantage of the temperature-dependent solubility characteristics of salt and potash in salt-potash brine. Salt has a lower solubility concentration than potash at higher temperatures (above 72° C.) and potash has a lower solubility concentration than salt at lower temperatures (below 72° C.). Increasing the temperature (e.g., up to 110° C. or boiling) of brine saturated with potash and salt produces salt precipitate, which may be extracted from the brine solution. Decreasing the temperature of the same brine (e.g., down to 20° C., or lower) produces potash precipitate, which may be extracted from the brine solution.

1.3. Benefits of the Vapor-Compression Cycle

The system and method advantageously use the energy efficiency of a vapor-compression cycle to heat or cool the salt-potash brine. The vapor-compression cycle may operate at unique thermodynamic operating pressures, pressure increase across the compressor(s), and temperature differences across the heat exchangers so as to minimize power consumption and depreciation cost of heat exchangers and pressure vessels. The brine may be entirely heated through heat exchangers from the vapor-compression cycle without the need to burn natural gas or other hydrocarbons.

The vapor-compression cycle may use clean water (e.g., liquid water, water-vapor, or steam) or refrigerant (e.g., R-134a) as a working fluid. Using water as the working fluid has the advantage of decreasing the capital cost and potential environmental impact of the overall system. Water also has the advantage of having a boiling temperature in a target temperature range, a high heat of vaporization, and a high density as a liquid.

Both the condenser heat exchanger and the evaporator heat exchanger in the vapor-compression cycle may function to reduce the overall operating cost and environmental impact of the potash processing system. The condenser heat exchanger may recapture heat (e.g., reduce operating cost) generated from compressing the working fluid by boiling the potash brine to produce potash-concentrated brine and water vapor. The evaporator heat exchanger, in turn, may recapture the water vapor (e.g., reduce the environmental impact) by condensing the water vapor from the boiling brine and turning the working fluid into saturated vapor before being compressed again.

1.4. Potash Process System Components

In embodiments, the potash processing system includes a brine concentrator heated by a condenser heat exchanger of a vapor-compression cycle (e.g., a heat pump). The condenser heat exchanger may heat the brine in the concentrator to an elevated temperature, which precipitates out some of the salt and increases the relative concentration of potash in the brine. Heat from the condenser may boil the brine to produce steam or water vapor. The concentrator may output separate flows of NaCl-precipitated slurry, potash-concentrated brine, and water vapor.

In embodiments, the vapor-compression cycle also includes an evaporator heat exchanger that transfers heat from the water vapor or steam from the boiling brine in the concentrator to change the phase of the working fluid to saturated vapor. The working fluid phase change occurs prior to compressing the working fluid with a compressor or blower.

The potash processing system also includes a crystallizer that separates potash from the potash-concentrated brine. A crystallizer cools the potash-concentrated brine to precipitate out potash from the brine. The crystallizer may be cooled by ground water from an aquifer, or by a heat exchanger that is itself cooled by ambient air or a second vapor compression cycle, e.g., a refrigeration chiller.

The remaining solution exiting the crystallizer, a potash-precipitated slurry, may then be passed through a centrifuge, which extracts a majority of the salt-brine solution, leaving damp potash paste. The potash paste may then be pelletized and dried or otherwise prepared for sale.

1.5. Overall System Benefits

In embodiments, the processing system may be mobile, which means that the processing equipment can be built in a factory on transportable skids, hauled to a well site for an indefinite period of time, and then moved to new sites. The processing system may also be module, which means the equipment may be scalable to the needs of specific well sites. Modularity enables the concept of reducing upfront investment and risk associated with large-scale central plant installations. Lessons learned from the early designed modular units can be incorporated into later installations. Resources on relatively isolated properties may be economically developed.

The disclosed processing system may dramatically reduce consumptive water use as compared to open-pond, solar-evaporation potash processing. In embodiments, water vapor boiled from the brine in the concentrator is almost entirely recovered and reused. This has the added benefit that only the very small fraction of the water still contained in the damp paste or paste emerging from the centrifuge and driven off in the final stage dryer is lost.

The system may also be used in colder climates where open-pond potash processing is not feasible. Significantly decreased water consumption combined with a relatively small and mobile installation footprint may increase the likelihood and decrease the cost of permitting at a well site.

In preferred embodiments, high-energy efficiency comparable to that achieved in large-scale, central-plant type installations, is an important part of making the vapor-compression cycle based potash processing system both technically and economically productive.

In embodiments, a potash processing system includes a concentrator configured to receive a brine containing potash from a brine source and heat the brine to produce precipitated NaCl, water vapor, and potash-concentrated brine. A potash processing system may further include a crystallizer configured to receive the potash-concentrated brine and precipitate potash from the potash-concentrated brine to produce potash saturated brine and potash-precipitated slurry. A potash processing system may further include a potash centrifuge configured to receive the potash-precipitated slurry and separate precipitated potash from the potash-precipitated slurry to produce potash paste. A potash processing system may further include a heat pump, the heat pump comprising a compressor configured to compress a working fluid; a condenser heat exchanger configured to transfer heat from the working fluid to the brine in the concentrator; an expansion valve configured to expand the working fluid; and an evaporator heat exchanger configured to evaporate the working fluid; and condense the water vapor to produce condensate.

In other embodiments, a potash processing system may further include a pelletizer configured to pelletize the potash paste and produce potash pellets; and a dryer configured to dry the potash pellets. Also, a potash processing system may further include a dryer configured to dry the potash paste and produce potash powder.

In other embodiments, a potash processing system may further include a pre-heater configured to transfer heat from the potash-concentrated brine to the brine or a feed heater configured to transfer heat from the condensate to the brine.

In other embodiments, the concentrator may be further configured to separate the precipitated NaCl from the potash-concentrated brine to produce NaCl-precipitated slurry. In addition, an NaCl centrifuge may be configured to separate water from the NaCl-precipitated slurry. The potash processing system may further comprise a pump and piping configured to transfer the condensate and NaCl-precipitated slurry to a return well.

In other embodiments, a potash processing system may further include a pre-heater configured to transfer heat from the potash-concentrated brine to the brine and a pump and piping configured to transfer and combine a portion of the potash-saturated brine with the potash concentrated brine. A pump and piping may be additionally added and configured to transfer a portion of the potash-saturated brine to a return well.

In embodiments, the working fluid of the potash processing system may be water.

A method for processing potash from a salt-potash brine includes: compressing a working fluid and transferring the working fluid to a condenser heat exchanger; transferring a brine to concentrator; heating the brine in the concentrator with heat from the condenser heat exchanger to produce precipitated NaCl, water vapor, and potash-concentrated brine; transferring the potash-concentrated brine to a crystallizer; precipitating potash from the potash-concentrated brine in the crystallizer to produce potash-saturated brine and potash-precipitated slurry; transferring the potash-precipitated slurry to a centrifuge; separating precipitated potash from the potash-precipitated slurry in the centrifuge to produce potash paste; expanding the working fluid through an expansion valve; and cooling the working fluid in an evaporator heat exchanger to produce condensate.

A method for processing potash from a salt-potash brine may further include: pelletizing the potash paste to produce potash pellets; drying the potash pellets; drying the potash paste to produce potash powder; transferring heat from the potash-concentrated brine to the brine; transferring heat from the condensate to the brine; separating in the concentrator the precipitated NaCl from the potash-concentrated brine to produce NaCl-precipitated slurry; combining a portion of the potash-saturated brine with the potash concentrated brine; or transferring a portion of the potash-saturated brine to a return well.

In the methods for processing potash from a salt-potash brine, the working fluid may be water.

### BRIEF DESCRIPTION OF THE DRAWINGS

FIG. 1 illustrates the weight percent solubility of KCl and NaCl as a function of temperature;

FIG. 2 illustrates a potash processing system;

FIG. 3 illustrates a temperature-entropy (T-s) diagram for a vapor compression cycle with water as the working fluid;

FIG. 4 illustrates a pressure-enthalpy (P-h) diagram for a vapor compression cycle with water as the working fluid;

FIG. 5 illustrates another embodiment of potash processing system.

### DETAILED DESCRIPTION

### 2. Detailed Description

2.1. Disclosure Applicability

The present disclosure covers apparatuses and associated methods for processing potash. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional,” “optionally” or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure covers methods, systems, and devices for potash processing. A potash processing systems uses a vapor-compression cycle (e.g., heat pump or refrigeration system) to separate potash from a brine containing potash. The system takes advantage of the energy efficiency of the vapor-compression cycle and the temperature-dependent solubility characteristics of salt and potash in a brine solution to extract potash in an energy efficient and water saving process.

2.2. Temperature Dependency of NaCL and Potash Solubility in a Brine

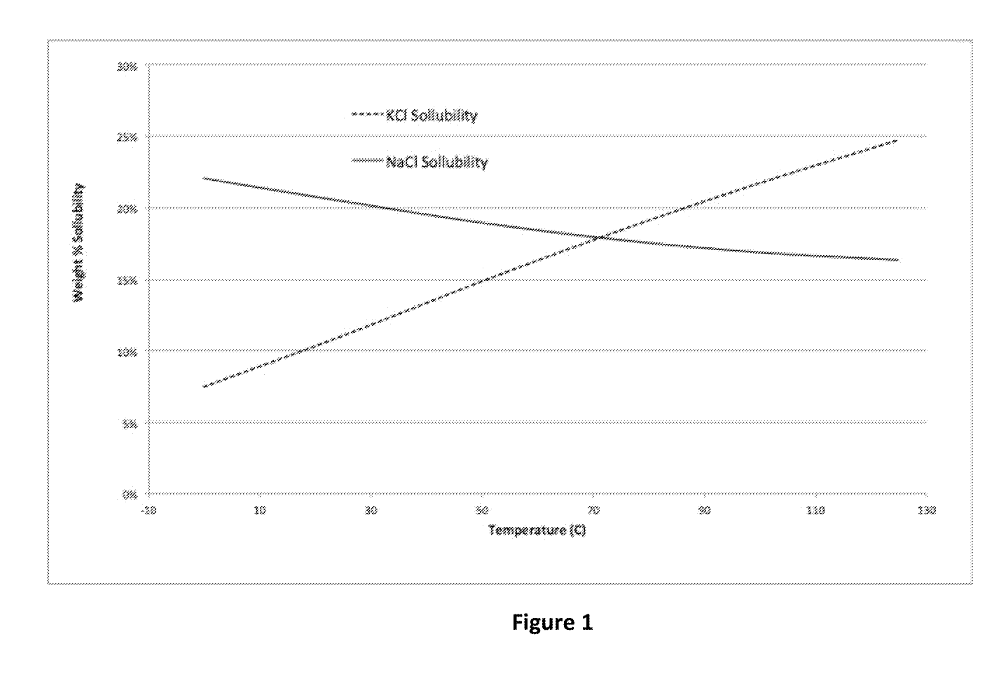

FIG. 1 illustrates the temperature-dependent solubility of NaCl and potash in a salt-potash brine solution. Between 0° C. and 130° C., the weight percent solubility of potash increases and the weight percent solubility of salt decreases. The weight percent solubility of potash and salt is about the same at 75° C. For example, the weight-percent solubility of salt and potash are about 17.9% in a 75° C. salt-potash brine. In the same solution, the weight-percent solubility of salt decreases to 16.8% at 105° C. and the weight-percent solubility of potash decreases to 13.4% at 35° C.

A potash processing system may separate salt or potash from salt-potash brine by heating or cooling the salt-potash brine. For example, a salt-potash brine solution at 30° C. saturated with salt and potash has a weight percent salt concentration of about 20% and a weight percent potash concentration of about 12%. A salt precipitate may be formed and suspended in the salt-potash brine by heating it to its boiling point, approximately 110° C. Additional salt precipitate may be formed as the salt-potash brine boils and water vapor in the form of steam leaves the brine. At the boiling temperature, the maximum weight percent solubility of the salt in the salt-potash brine is about 17%. The salt precipitate suspended in the brine may be mechanically captured to produce an NaCl-precipitated slurry. The remaining brine may be potash concentrated compared to the original, 30° C. brine, because less salt is in the brine. The potash-concentrated brine may then be cooled to form a potash precipitate in the potash-concentrated brine. The potash precipitate may be mechanically captured to produce potash-precipitated slurry.

The potash processing system and method may operate at optimal potash brine processing temperatures so as to maximize the amount of potash extracted from the brine for a given energy input and equipment cost.

2.3. Potash Processing Components

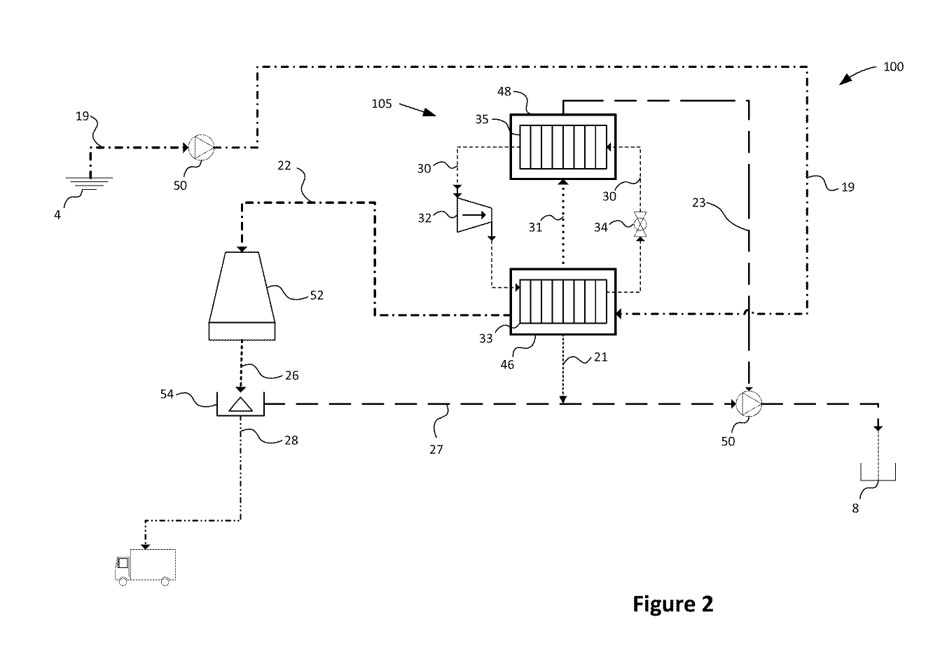

FIG. 2 illustrates an embodiment of a potash processing system 100. In embodiments, a pump 50 or other transport device transfers brine-containing potash 19 from a brine source 4 to a potash concentrator 46. In FIG. 2 and other similar figures, brine, water, or other fluids are depicted as lines between the components illustrated in the figures. The brine-containing potash 19 is preferably saturated with potash, meaning that decreasing the temperature of the brine-containing potash 19 will precipitate potash from the brine. The brine-containing potash is also likely salt saturated, meaning that increasing the temperature of the brine will precipitate salt from the brine. The precipitated salt or potash may remain in suspension as a precipitate.

The concentrator 46 heats the brine-containing potash. The brine may be brought to a boil, causing salt crystals or precipitate to form in the brine solution. The concentrator may be configured to separate the salt precipitate from the brine, leaving a potash-concentrated brine. Precipitated salt may leave the concentrator in the form of an NaCl precipitated slurry 21. The NaCl precipitated slurry 21 may be returned to a return well 8 via a pump 50 or other transport device.

Because some NaCl (in the form of NaCl precipitated slurry 21) may be removed from the brine 19 in the concentrator 46, the solution leaving the concentrator 46 may be potash concentrated brine 22. The potash concentrated brine 22 may have a higher concentration of potash because it may contain less dissolved NaCl. However, the potash concentrated brine 22 may not be potash saturated, meaning more potash may be able to dissolve in the potash concentrated brine 22. The potash concentrated brine 22 may be transferred to a potash crystallizer 52.

The potash crystallizer 52 takes advantage of the temperature dependent solubility properties of potash in the potash concentrated brine 22. The potash crystallizer 52 cools the potash concentrated brine 22, causing potash to precipitate out of the solution and form potash precipitate that may be suspended in the brine. The potash crystallizer may then separate the potash from the solution in the form of a potash precipitated slurry 26

The potash precipitate slurry 26 may be transferred to a centrifuge 54. The centrifuge 54 may extract potash-saturated brine 27 from the potash precipitate slurry 26 to produce a potash paste 28. The potash saturate brine 27 may be transferred to a return well 8. The potash paste 28 may be further processed for sale or use in products such as fertilizer.

2.4. Vapor-Compression Cycle Components

Referring again to FIG. 2, a vapor heat compression cycle includes a compressor or blower 32, a condenser heat exchanger 33, an expansion valve 34, and an evaporator heat exchanger 35. The vapor-compression cycle 105 may use water as the working fluid 30. Alternatively, the vapor-compression cycle may use a refrigerant, such as R-134A, as the working fluid 30. In the potash concentrator 46, the condenser heat exchanger 33 may heat the brine at or near its boiling point temperature.

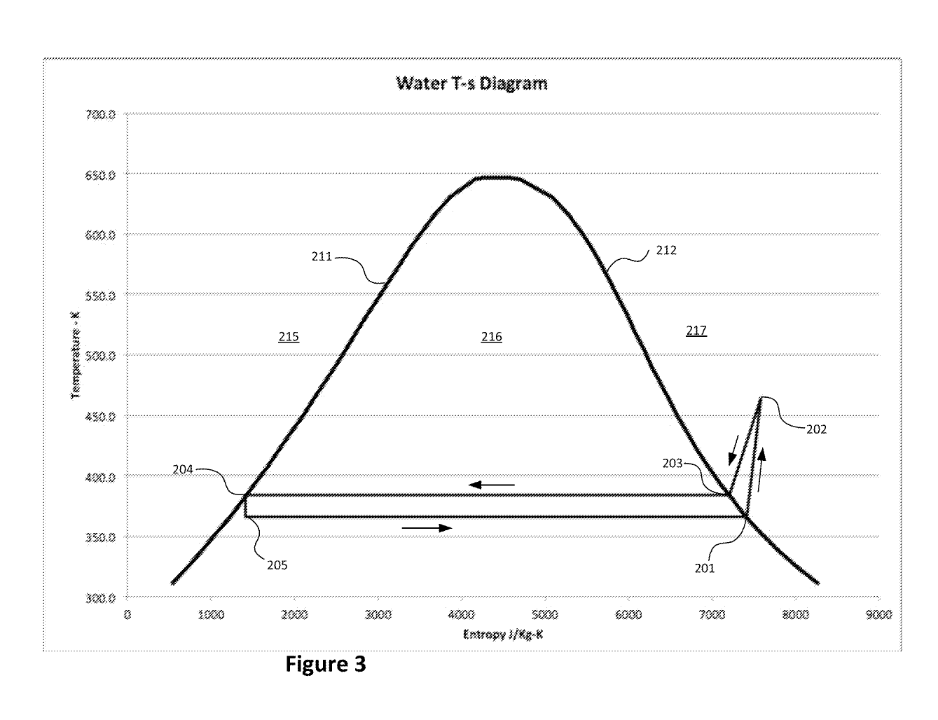

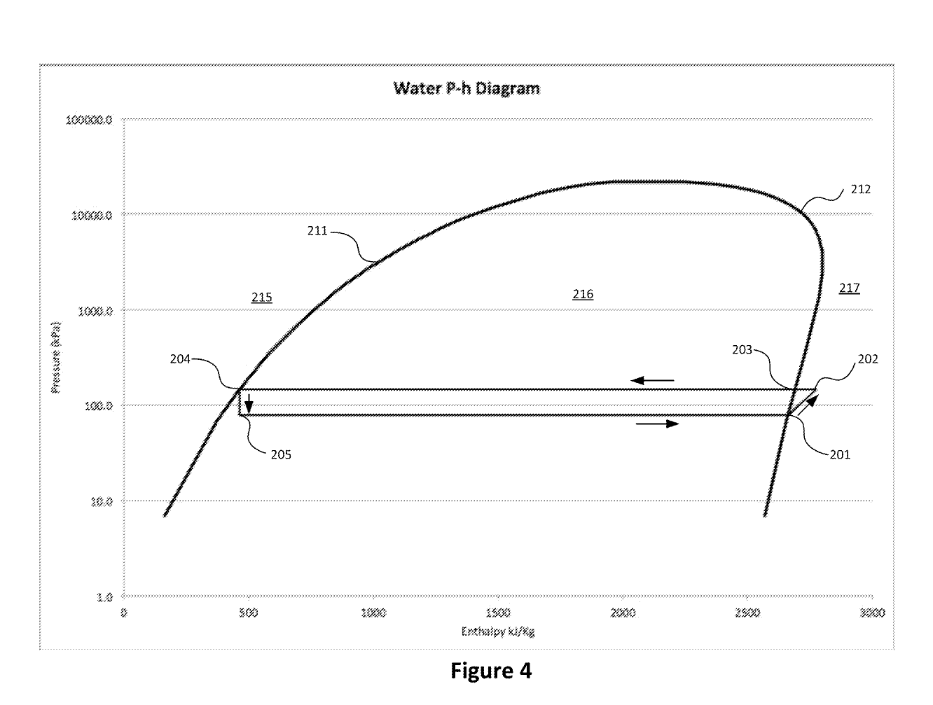

FIGS. 3 and 4 illustrate temperature-entropy (T-s) and pressure-enthalpy (P-h) diagrams, respectively, for the vapor-compression cycle 105 with water as the working fluid 30. The T-s and P-h diagrams include a liquid saturation line 211 and a vapor saturation line 212. The diagrams also illustrate liquid region 215 (left of liquid saturation line 211), liquid-vapor region 216 (between liquid saturation line 211 and vapor saturation line 212), and saturated vapor region 217 (right of vapor saturation line 212). The diagrams also illustrate various points (201-205) of a near-ideal vapor-compression cycle.

Referring to FIGS. 2, 3, and 4, the vapor-compression cycle 105 may be modeled as a near-ideal cycle beginning at saturated-vapor point 201, where the working fluid 30 enters the compressor or blower 32 as a saturated, or near-saturated vapor. The compressor or blower 32 compresses saturated water vapor in a non-isentropic process, as illustrated by saturated-vapor point 201 and supersaturated vapor point 202. The condenser heat exchanger 33 then cools the supersaturated vapor at a constant pressure until reaching the vapor-saturation point 203, and then the liquid-saturation point 204. At liquid-saturation point 204, the working fluid 30 enters the expansion valve 34 to throttle the pressure of the water until liquid-vapor point 205. At liquid-vapor point 205, the working fluid is a water-vapor mixture that enters the condenser heat exchanger 33 where the water vapor is heated until it becomes saturated, or near-saturated vapor at saturated-vapor point 201.

Referring back to FIG. 2, the condenser heat exchanger 33 cools the working fluid 30, which may be a supersaturated vapor, by transferring heat from the vapor into the brine 19. In embodiments, the brine 19 boils, producing in the concentrator 46: water vapor or steam 31, potash-concentrated brine 22, and NaCl-precipitated slurry 21. The water vapor or steam 31 is transferred to the water vapor condenser 48 where the water vapor or steam 31 transfers heat back into the working fluid 30. At this stage, the working fluid may become a saturated, or near-saturated vapor, ready to be compressed by the compressor or blower 32. The water vapor or steam 31, after losing heat to the working fluid, condenses to become condensate 23. The condensate 23 may be combined with the NaCl precipitated slurry 21 or other byproducts that may be transferred to the return well 8.

2.5. Energy Efficiency

Referring back to FIGS. 2, 3, and 4, the vapor-compression cycle 105 may operate at unique thermodynamic operating conditions to minimize power consumption and increase the useful life of the components. The operating conditions include the operating pressures, or the pressure increase across the compressor or blower 32 and the pressure decrease across the expansion valve 34. The operating conditions also include the temperature differences across the condenser heat exchanger 33 and evaporator heat exchanger 35.

The efficiency of a heat pump vapor compression cycle may be characterized by its Coefficient of Performance (“COP”). The higher the COP, the less power is required to operate the potash processing system. COP is defined as the amount of heat output divided by the amount of energy input (usually electrical energy). Referring specifically to FIG. 4, the COP of the vapor compression cycle 105 may be quantified as:

$$\frac{{h}_{202} - {h}_{204}}{{h}_{202} - {h}_{201}}$$

where:
h₂₀₂ is the enthalpy at the supersaturated vapor point 202, h₂₀₄ is the enthalpy at the liquid-saturation point 204, and h₂₀₁ is the enthalpy at the saturated-vapor point 201.

In the illustrated embodiments, h₂₀₁ is approximately 2662 kJ/kg, h₂₀₂ is approximately 2773 kJ/kg, and h₂₀₄ is approximately 462 kJ/kg. Therefore, the approximate COP of the vapor compression cycle 105 may be approximately 21. The COP of a vapor compression cycle heat pump may be increased by two to four percent for each degree-C. the evaporator heat exchanger 35 is raised or the condensing heat exchanger 33 is lowered.

2.6. Water Savings

In embodiments, the processes described above may consume very little water, conserving a significant amount of water as compared to evaporation-pond potash processing techniques. For example, referring back to FIG. 2, the vapor-compression cycle 105 is a closed-loop cycle, meaning that the working fluid 30 is continuously recycled through the process. If water is used as the working fluid 30, the water is continuously recycled through the closed-loop vapor-compression cycle 105. Additionally, the water vapor or steam 31 boiled from the brine 19 in the concentrator 46 may be captured by the water vapor condenser 48 and later transferred to a return well 108. Finally, the potash-saturated brine 27 may also be transferred to a return well 108 or recycled into the processing system. There may be some water remaining in the potash paste 28, but that water may represent less than one percent of the water contained in the brine 19 entering the potash processing system 100.

2.7. Additional Potash Processing Components

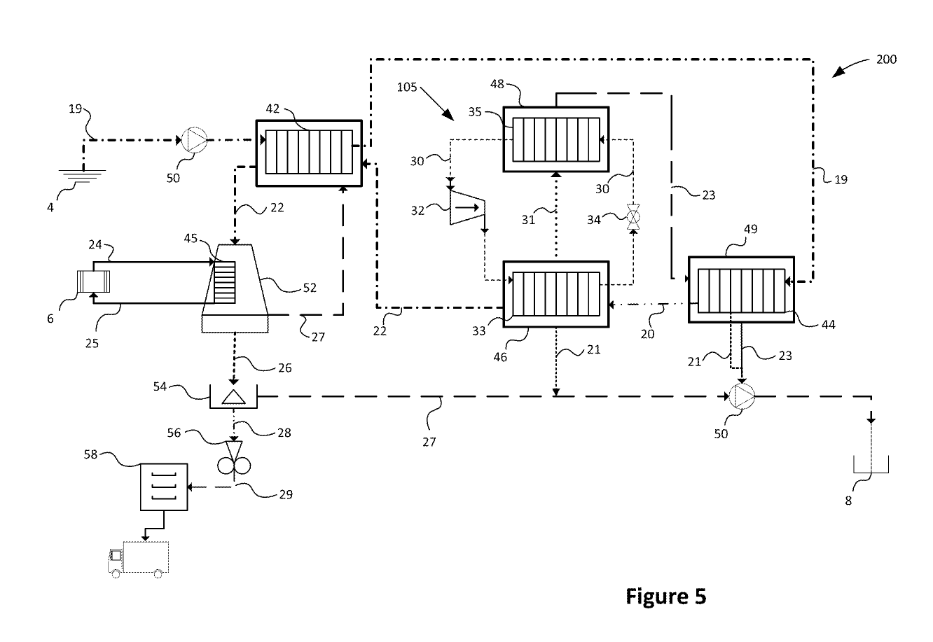

In embodiments, additional components may be added to the potash system to improve the efficiency or increase the amount of potash extracted from salt-potash brine. FIG. 5 illustrates an exemplary potash processing system 200 with additional heat exchangers which may be used to increase the operating efficiency of a potash processing system. Potash processing systems 100 (from FIG. 2) and 200 include similar vapor-compression cycle 105 components. For example, the vapor compression cycle 105 in potash processing system 200 includes the compressor or blower 32, condenser heat exchanger 33, expansion valve 34, and evaporator heat exchanger 35. The potash processing system 200 also includes similar potash processing components, including the potash concentrator 46, water vapor condenser 48, potash crystallizer 52, and centrifuge 54.

The potash processing system 200 may also include a pre-heater heat exchanger 42. The pre-heater heat exchanger 42 may simultaneously heat the brine 19 and cool the potash concentrated brine 22. FIG. 5 illustrates the pre-heater heat exchanger 42 heating the brine as one of the first processing steps after the brine 19 is extracted from the brine source 4. The pre-heater heat exchanger 42 also cools the potash concentrated brine 22 after it leaves the potash concentrator 46 and before the potash concentrated brine 22 enters the potash crystallizer 52.

The potash processing system 200 may also include a feed heater heat exchanger 44. The feed heater heat exchanger 44 may simultaneously heat the brine 19 and cool the condensate 23 before the brine 19 enters the potash concentrator 46. The pre-heater heat exchanger and the feed heater heat exchanger may have the effect of increasing the temperature of the condenser heat exchanger 33, which may increase the vapor compression cycle 105 COP, and thus its efficiency.

The potash processing system 200 may also include a crystallizer heat exchanger 45, which acts to cool the potash-concentrated brine 22 and produce potash precipitate in the potash crystallizer 52. The crystallizer heat exchanger 45 may be cooled by a cooling source 6, with cooling supply line 24 and cooling return line 25. In locations where a ground water aquifer is accessible, the cooling source 6 may be a ground water aquifer. Cooling supply 24 and cooling return 25 may transfer water to and from the aquifer to cool the crystallizer in a closed-loop system without evaporating water from the aquifer.

In other embodiments, if the processing system is located where the outdoor ambient temperature is sufficiently low, the cooling source 6 may be an air-to-water or air-to-glycol heat exchanger cooled by ambient air. Also as an alternative, the cooling source 6 may be a second vapor-compression cycle (e.g., a refrigeration chiller). A refrigeration chiller acting as a cooling source 6 may be more practical where an aquifer is not available or the cost of accessing the aquifer is excessive.

If the cooling source 6 is a refrigeration chiller, cooling supply line 24 and cooling return line 25 may be refrigeration lines that transport refrigerant to and from the crystallizer heat exchanger 45. Using refrigerant in the crystallizer heat exchanger 45 increases the second vapor compression cycle's COP by taking advantage of the phase-change properties of the refrigerant inside the second vapor compression cycle's condenser and evaporator.

Similar to the pre-heater heat exchanger 42, a refrigeration chiller condenser may be used to pre-heat the brine 19. Additionally, like vapor-compression cycle 105 (e.g., the heat pump) used to heat or boil the brine 19, a refrigeration chiller may be operated at unique thermodynamic operating pressures, pressure increases across the compressor, and temperature differences across the heat exchangers so as to minimize operating cost. A cooling source 6 that is a refrigeration chiller may also be able to lower the potash-concentrated brine to temperatures lower than those achievable through aquifer water-cooling alone. A lower temperature potash-concentrated brine may produce more potash precipitate, allowing the potash crystallizer 52 to extract greater quantities of potash for a given amount of potash-concentrated brine 22.

Referring again to FIG. 5, the potash crystallizer 52 may produce a separate stream of potash-saturated brine 27. The potash-saturated brine 27 may be combined with potash concentrated brine 22 in the pre-heater heat exchanger 42. Potash-saturated brine 27 may include precipitated potash suspended in solution. The precipitated potash may act as a seed crystal in the combined potash-saturated brine 27 and potash concentrated brine 22 entering the potash crystallizer 52. Having precipitated potash seed crystals at the inlet of the potash crystallizer 52 may increase the efficiency of the potash crystallizer 52 to form greater amounts or potash precipitate.

The potash processing system 200 may also include a pelletizer 56 and dryer 58. The pelletizer 56 may receive the potash paste 28 and convert it into potash pellets 29. Potash pellets 29 may have a higher value than potash paste 28 in some markets. The potash pellets 29 may be dried in dryer 58. The end product may then be transported away from the potash processing site.

2.8. System Modularity and Transportability

Various components described the potash processing systems 100 and 200 may or may not be included depending on the site-specific needs and the desired end product. The potash processing system 100 or 200 may be mobile and modular, meaning that different components may be built on transportable skids and used, replaced, or upgraded as needed. For example, the components in the vapor compression cycle 105 may be combined on a single transportable skid. Similarly, the potash crystallizer 52, centrifuge 54, pelletizer 56, or dryer 58 may be combined on a transportable skid. The pre-heater heat exchanger 42 and feed heater heat exchanger 44 may also be combined on a transportable skid or added to another skid containing the components of the vapor compression cycle 105. Likewise, a cooling source 6 that is an air-based heat exchanger or a second vapor compression cycle (e.g., a refrigeration chiller), may also be built on its own transportable skid and used at well sites on an as-needed basis. A refrigeration chiller skid may be used until a ground-water source becomes available after obtaining the proper permits and drilling a well to the aquifer.

The components of the potash processing system 100 or 200 may be scalable according to the potash processing needs of typical or specific potash well sites. For example, at some well sites, it may be possible to extract and process the brine 19 at much higher rates. Increased processing rates will likely require larger capacity vapor compression cycle 105 components. Other potash processing system components may also be sized according to the processing needs of a specific well site.

### 3. Examples

3.1. A Potash Processing System with Operation Temperatures

The following examples are illustrative only and are not intended to limit the disclosure in any way.

### EXAMPLES

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

FIG. 5 illustrates an example potash processing system 200. In one exemplary embodiment, a brine 19 containing potash is extracted from a brine source 4 at an approximate temperature of 30° C. The brine may be saturated with both salt and potash an have a weight percent salt concentration of about 20% and a weight percent potash concentration of about 12%.

Other weight percent potash and salt concentrations are possible by changing the brine 19 extraction temperature. The extraction temperature and thus the weight percent concentration is a function of the injection temperature of a water or brine solution added to an injection or return well. Higher concentration potash brine may be extracted by increasing the temperature of brine or water injected into an injection or return well. Extraction temperature may also be a function of the proximity of the injection or return well to the extraction well or brine source 4.

In this example, the brine 19 may be pre-heated in a pre-heater heat exchanger 42. The source of heat from the pre-heater heat exchanger 42 comes from the heat in the potash concentrated brine 22 coming from the potash concentrator 46. The brine 19 may be heated to a temperature of approximately 65° C.

The brine 19 may then be transferred to a feed heater heat exchanger 44 and heated to a temperature of approximately 75° C. At that temperature, the brine 19 becomes saturated NaCl brine 20. The feed heater heat exchanger 44 may be heated by condensate 23 captured by the water vapor condenser 48. After heating the feed heater heat exchanger 44, the condensate 23 may be transferred to the injection or return well 8 to increase the temperature of the brine or water injected into the injection or return well 8.

The increase in temperature of the brine 19 or saturated NaCl brine 20 by the feed heater heat exchanger 44 may cause some salt to precipitate out of the brine 19 or 20. The precipitated salt may be separated in the feed salt concentrator 49 and extracted as an NaCl precipitated slurry 21. In the depicted embodiment, the NaCl precipitated slurry 21 is combined with the condensate 23 exiting the feed heater heat exchanger 44.

In the exemplary embodiment, the saturated NaCl brine 21 is transferred to the potash concentrator 46 where the saturated NaCl brine 21 is brought to a boil at approximately 110° C. The boiling of the saturated NaCl brine 21 produces water vapor or steam 31, NaCl precipitated slurry 21, and potash concentrated brine 22. The temperature of the potash concentrated brine 22 may be approximately 105° C. At that temperature, the potash concentrated brine 22 may have a weight percent salt concentration of about 17% and a weight percent potash concentration of about 22%.

The water vapor or steam 31 produced in the potash concentrator 22 is transferred to the water vapor condenser 48 where it heats and vaporizes the working fluid 30 in the evaporator heat exchanger 35. The water vapor or steam 31 is in turn cooled to become condensate 23 where it is used as discussed above.

The potash concentrator 46 also separates the NaCl precipitated slurry 21 from the potash concentrated brine 22. In the depicted embodiment, the NaCl precipitated slurry 21 is transferred to a return 8. Alternatively, the NaCl precipitated slurry 21 may be dried or otherwise processed for use in various applications, including road salt, water-softener salt, or other applications.

The potash concentrated brine 22 is transferred to the pre-heater heat exchanger 42 where it heats the incoming brine 19. The potash concentrated brine 22 is, in turn, cooled to approximately 35° C. before being transferred to the potash crystallizer 52. In the potash crystallizer 52, the potash concentrated brine is further cooled to precipitate potash out of the brine. The precipitated potash is captured and extracted as potash precipitated slurry 26. The remaining brine is potash saturated brine 27 and may contain some potash precipitate suspended in the solution. The potash-saturated brine is combined with the potash concentrated brine 22, which may help speed the process of precipitating additional potash from the potash concentrated brine 22 in the potash crystallizer 52.

Cooling water supply 24 from a cooling source 6 may be from a ground water aquifer. The cooling water supply 24 cools the potash concentrated brine 22 in the potash crystallizer 52 through the crystallizer heat exchanger 45. The temperature of the cooling water supply may be approximately 20° C. before entering the crystallizer heat exchanger 45. The cooling water supply 24 may be heated to approximately 26° C. in the crystallizer heat exchanger 45 before returning as cooling water return 25 to the cooling source 6.

From the crystallizer 52, the potash-precipitated slurry 21 is transferred to a centrifuge 54 where water is extracted to form potash paste 28 and potash saturated brine 27. The potash saturated brine 27 may be combined with the NaCl precipitated slurry 21 and the condensate 23 before being returned to the return well 8.

In the depicted embodiment, the potash paste 28 is transferred to the pelletizer 56 to form potash pellets 29, which are later dried in the dryer 58. The potash may then be transported from the well site or otherwise processed and transported for sale.

The components of the disclosed embodiments, as generally described herein, could be arranged and designed in a wide variety of different configurations. Accordingly, the above detailed description of the embodiments of the systems and methods of the disclosure is not intended to limit the scope of the disclosure, but is merely representative of possible embodiments of the disclosure. In addition, the steps of any disclosed method do not necessarily need to be executed in any specific order, or even sequentially, nor do the steps need to be executed only once, unless otherwise specified.

In the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, inventive aspects lie in a combination of fewer than all features of any single foregoing disclosed embodiment. Changes may be made to the details of the above-described embodiments without departing from the underlying principles set forth herein.

What is claimed is:

1. A potash processing system, the system comprising:
a concentrator configured to:
receive a brine containing potash from a brine source; and
heat the brine to produce precipitated NaCl, water vapor, and potash-concentrated brine;
a crystallizer configured to:
receive the potash-concentrated brine; and
precipitate potash from the potash-concentrated brine to produce potash saturated brine and potash-precipitated slurry;
a potash centrifuge configured to:
receive the potash-precipitated slurry; and
separate precipitated potash from the potash-precipitated slurry to produce potash paste;
a heat pump, the heat pump comprising:
a compressor configured to compress a working fluid;
a condenser heat exchanger configured to transfer heat from the working fluid to the brine in the concentrator;
an expansion valve configured to expand the working fluid; and
an evaporator heat exchanger configured to:
evaporate the working fluid; and
condense the water vapor to produce condensate.

2. The potash processing system of claim 1, further comprising:
a pelletizer configured to pelletize the potash paste and produce potash pellets;
a dryer configured to dry the potash pellets.

3. The potash processing system of claim 1, further comprising:
a dryer configured to dry the potash paste and produce potash powder.

4. The potash processing system of claim 1, further comprising a pre-heater configured to transfer heat from the potash-concentrated brine to the brine.

5. The potash processing system of claim 1, further comprising a feed heater configured to transfer heat from the condensate to the brine.

6. The potash processing system of claim 1, wherein the concentrator is further configured to separate the precipitated NaCl from the potash-concentrated brine to produce NaCl-precipitated slurry.

7. The potash processing system of claim 6, further comprising an NaCl centrifuge configured to separate water from the NaCl-precipitated slurry.

8. The potash processing system of claim 6, further comprising a pump and piping configured to transfer the condensate and NcCl-precipitated slurry to a return well.

9. The potash processing system of claim 1, further comprising:
a pre-heater configured to transfer heat from the potash-concentrated brine to the brine; and
a pump and piping configured to transfer and combine a portion of the potash-saturated brine with the potash concentrated brine.

10. The potash processing system of claim 1, further comprising a pump and piping configured to transfer a portion of the potash-saturated brine to a return well.

11. The potash processing system of claim 1, wherein the working fluid is water.

12. A method for processing potash from a salt-potash brine, the method comprising:
compressing a working fluid and transferring the working fluid to a condenser heat exchanger;
transferring a brine to concentrator;
heating the brine in the concentrator with heat from the condenser heat exchanger to produce precipitated NaCl, water vapor, and potash-concentrated brine;
transferring the potash-concentrated brine to a crystallizer;
precipitating potash from the potash-concentrated brine in the crystallizer to produce potash-saturated brine and potash-precipitated slurry;
transferring the potash-precipitated slurry to a centrifuge;
separating precipitated potash from the potash-precipitated slurry in the centrifuge to produce potash paste;
expanding the working fluid through an expansion valve;
cooling the working fluid in an evaporator heat exchanger to produce condensate.

13. The potash processing method of claim 12, further comprising:
pelletizing the potash paste to produce potash pellets; and
drying the potash pellets.

14. The potash processing method of claim 12, further comprising drying the potash paste to produce potash powder.

15. The potash processing method of claim 12, further comprising transferring heat from the potash-concentrated brine to the brine.

16. The potash processing method of claim 12, further comprising transferring heat from the condensate to the brine.

17. The potash processing method of claim 12, further comprising separating in the concentrator the precipitated NaCl from the potash-concentrated brine to produce NaCl-precipitated slurry.

18. The potash processing method of claim 12, further comprising combining a portion of the potash-saturated brine with the potash concentrated brine.

19. The potash processing method of claim 12, further comprising transferring a portion of the potash-saturated brine to a return well.

20. The potash processing method of claim 12, wherein the working fluid is water.
